(19) United States
(12) Patent Application Publication
(10) Pub. No.: US 2014/0248014 A1
(43) Pub. Date: Sep. 4, 2014

(54) ROLLING BEARING

(71) Applicants: Gunter Schmid, Nurnberg (DE); Jurgen Hilbinger, Neustadt/A. (DE)

(72) Inventors: Gunter Schmid, Nurnberg (DE); Jurgen Hilbinger, Neustadt/A. (DE)

(73) Assignee: SCHAEFFLER TECHNOLOGIES GMBH & CO. KG, Herzogenaurach (DE)

(21) Appl. No.: 14/343,231

(22) PCT Filed: Jul. 13, 2012
(86) PCT No.: PCT/EP2012/063794

§ 371 Date: Mar. 6, 2014

(30) Foreign Application Priority Data
Sep. 7, 2011 (DE) 10 2011 082 221.6

(51) Int. Cl. F16C 41/00; G01B 7/00

(52) U.S. Cl. CPC F16C 41/00; G01B 7/003
USPC 384/448

(57) ABSTRACT

A rolling bearing is provided including an inner bearing ring (3) and an outer bearing ring (2), movable relative to one another, and a dimensional scale (11) placed on either the inner or the outer bearing ring (3, 2) and detectable by a sensor (13) placed on the other bearing ring (2, 3). According to the invention, the rolling bearing (1) includes a measurement ring (10) having the dimensional scale (11) and is fixed to the inner bearing ring (3) or the outer bearing ring (2).

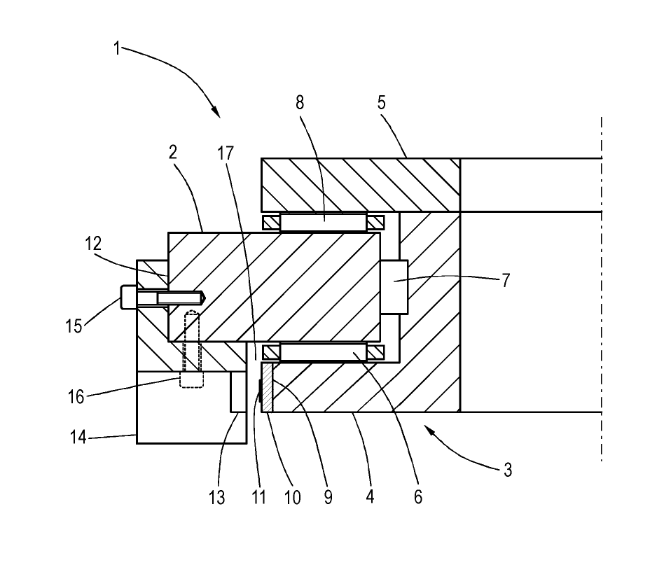

### FIELD OF THE INVENTION

The invention relates to a rolling bearing with an inner bearing ring and an outer bearing ring that can move relative to each other and with a dimensional scale that is attached either to one of the inner bearing ring or to the outer bearing ring and can be detected by a sensor attached to the other of the bearing rings.

### BACKGROUND

Rolling bearings of this type are used, for example, for rotary tables in machine tools. These involve highly dynamic direct drives that are used for the milling or turning processing of workpieces. A rotary table is driven by a torque motor and associated transformers and regulators. For milling and turning processes, a measurement system with high accuracy and angle resolution is preferred, wherein both optical and also magnetoresistive angle measurement systems are offered.

Rotary table bearings with the designation YRT or YRTM are made by the applicant. In these bearings, the outer bearing ring, which is also designated as a housing plate, is bolted to a machine base or rotary table base. The inner bearing ring, which is also designated as a thrust collar, is constructed so that it can rotate and is bolted to the rotary table. The thrust collar is often connected to an upper shaft washer that is turned together with the thrust collar. Axial (thrust) bearings/radial bearings of this type are described in the publication “Axial/radial bearings with integral angular measuring system,” published in September 2007 by Schaeffler KG.

In order to obtain fault-free electrical angle signals, a defined distance must be precisely set between a sensor installed in a measurement head and a dimensional scale. This distance or measurement gap is set by placing adjustment attachments in the thrust bearing/radial bearing YRTM. The adjustment attachments are thin metal films that are supplied in different thicknesses. The measurement head is mounted on the non-rotating outer bearing ring. For the setup of such a thrust bearing/radial bearing with an integrated angle measurement system, a PC, an interface cable between the PC and the measurement system, and special software are required to detect the measurement gap electronically by the signal strength. In order to correctly set the measurement gap and thus the signal strength, normally multiple iterative tests are required. The necessary exact setting of the distance is therefore complicated due to the necessary aids and results in a high expenditure of time.

In addition to optically detectable measurement bodies, it has already been proposed to perform an angle measurement with magnetically coded angle rings. In DE 10 2008 033 616 A1 originating from the applicant, a bearing is described in which a dimensional scale is produced by the application of a magnetic material. This magnetic material can be applied as a pasty mass or in a plastic matrix. The coating required for this can be performed economically, however, only for smaller rolling bearings with an inner diameter of approx. 50 to 460 mm. Larger bearings, for example, with diameters up to 3000 mm, cannot be produced economically in this way, because the coating devices and galvanic baths required for these larger bearings would be very large. In addition, a plurality of magnetic poles with a pole width of 500 μm must be generated, which is possible only little by little. For larger bearings, the coding time required for generating the dimensional scale increases significantly, resulting in high production costs.

### SUMMARY

Starting from the disadvantages of the known prior art, the invention is based on the objective of providing a rolling bearing with a dimensional scale that can be used without complicated adjustment of a measurement gap.

To meet this objective, it is provided for a rolling bearing of the type noted above that, according to the invention, it comprises a measurement ring that has the dimensional scale and is attached to the inner bearing ring or the outer bearing ring.

The invention involves the knowledge that the inner and the outer bearing rings of the rolling bearing are produced with very high precision in the range of a few hundredths of a millimeter, wherein concentric runout and axial runout within a few thousandths of a millimeter are achieved. This produces a sufficiently accurate and constant distance between a surface of the outer bearing ring and a surface of the inner bearing ring, wherein the measurement ring is attached either to one of the inner bearing ring or the outer bearing ring and the sensor is attached to the other of the bearing rings. The previously required complicated manual adjustment of the measurement gap between the dimensional scale and sensor can be eliminated, because the distance between the surfaces of the inner bearing ring and the outer bearing ring is produced with high precision.

An especially precise angle measurement is made possible if the inner bearing ring or the outer bearing ring has an attachment surface for the sensor that is arranged at a defined distance to the measurement ring or a contact surface of the measurement ring. In this way, the sensor can be attached to one of the bearing rings at a defined position that has a defined distance to the measurement ring or advantageously to a contact surface of the measurement ring.

In the scope of the production of the rolling bearing according to the invention it can be provided that the attachment surface for the sensor and the contact surface of the measurement ring are produced with a shoe grinding method. In this way, the desired precisely defined distance can be generated.

One refinement of the invention provides that the dimensional scale of the measurement ring has an inductively detectable angular division that can be scanned by an inductive sensor. The inductively detectable angular division can be generated in a significantly simpler way than the mentioned coating with a magnetic material. In addition, the inductively detectable angular division can also be attached relatively quickly and cost-effectively also for bearings with large inner diameters, for example, for inner diameters between 500 mm and 3000 mm.

It is also within the scope of the invention that the measurement ring and the inner bearing ring or the measurement ring and the outer bearing ring are connected to each other by an interference fit. The measurement ring is produced separately from the inner or outer bearing ring and provided with a dimensional scale. Then the measurement ring is pressed onto the inner bearing ring or the outer bearing ring. The contact surface of the measurement ring on the inner bearing ring or the outer bearing ring is located at a defined distance to the attachment surface for the sensor on the other ring, wherein the required exact distance is produced through which the exact and constant measurement gap is produced.

One especially preferred construction of the invention provides that the rolling bearing comprises a rotating inner bearing ring with a thrust collar and an angle washer connected to it and that the measurement ring is mounted on the thrust collar or the shaft washer. Accordingly, the rotating shaft washer and the thrust collar are connected rigidly to each other and the shaft washer and the thrust collar are provided with tracks for rolling bodies.

In the rolling bearing according to the invention, the inductive sensor can be screwed to the fixed outer bearing ring, so that the installation of the sensor is extremely easy, because no measurement gap must be set. Setting the rolling bearing in operation for use, for example, as a rotary table bearing of a machine tool, consists entirely in the screwing in of the inductive sensor, without the necessity of adjustment work, such as the iterative adjustment of the measurement gap.

### BRIEF DESCRIPTION OF THE DRAWINGS

One preferred embodiment of the rolling bearing formed according to the invention will be described in more detail below with reference to the accompanying drawings. The single drawing here shows a sectioned view of a rolling bearing formed according to the invention.

### DETAILED DESCRIPTION OF THE PREFERRED EMBODIMENTS

The rolling bearing 1 shown in the drawing comprises a fixed outer bearing ring 2 and an inner bearing ring 3 that can rotate relative to the outer bearing ring 2. The inner bearing ring 3 comprises essentially a thrust collar 4 that is connected to an shaft washer 5. As shown in the drawing, the angle ring 4 and the shaft washer 5 together form a C-profile that comprises tracks for rolling bodies 6, 7, 8. The rotating inner bearing ring 3 is supported in the outer bearing ring 2 so that it can rotate via the rolling bodies 6, 7, 8.

The thrust collar 4 has a circumferential cylindrical contact surface 9 for a measurement ring 10. The measurement ring 10 is connected to the inner bearing ring 3, more precisely to the thrust collar 4, via an interference fit. On its outside, the measurement ring 10 has an inductively detectable dimensional scale 11. In the shown embodiment, the dimensional scale 11 comprises a plurality of parallel axial lines that are formed on the outside of the measurement ring 10. In the drawing, the dimensional scale 11 is shown enlarged for illustrative purposes.

The outer bearing ring 2 has on its outside an attachment surface 12 on which is mounted a measurement head 14 with a sensor 13. The sensor 13 is an inductive sensor that detects the dimensional scale 11 and generates corresponding angle signals that are used for controlling a rotational movement of the inner bearing ring 3 of the rolling bearing 1. The attachment of the measurement head 14 on the outer bearing ring 2 is realized by a screw 15 whose longitudinal axis runs in the radial direction. Obviously, for mounting the measurement head 14, two or more such screws 15 could be used. As shown by the screw 16 drawn with dashed lines, the measurement head 14 could alternatively also be attached by at least one screw 16 arranged in the axial direction.

An extremely precise measurement gap 17 is formed between the sensor 13 and the measurement ring 10. The constant distance between the sensor 13 and the measurement ring 10 involves the fact that both the attachment surface 12 for the measurement head 14 with reference to the track on the outer bearing ring 2 on which the rolling bodies 7 roll and also the contact surface 9 for the measurement ring 10 with reference to the track on the inner bearing ring 3 on which the rolling bodies 7 also roll are produced together via a shoe grinding method. In this way, the necessary precise and constant distance between the sensor 13 and measurement ring 10 can be generated. The separately produced measurement ring 10 provided with the dimensional scale 11 is pressed onto the contact surface 9 of the angle ring 4. For the assembly of the rolling bearing 1, for example, in a rotary table of a machine tool, only the measurement head 14 that comprises the sensor 13 is bolted to the outer bearing ring 2, which automatically produces the required measurement gap 17. The precise measurement gap generated in this way makes an individual calibration or adjustment unnecessary.

The rolling bearing 1 is suitable for use in metal-cutting machine tools, for A, B, and C-axes, and also for rotary tables, the support of swivel bridges, rotational axle bearings in fork milling heads, milling heads in turning machines, and the like.

### LIST OF REFERENCE NUMBERS

1 Rolling bearing
2 Outer bearing ring
3 Inner bearing ring
4 Thrust Collar
5 Shaft washer
6 Rolling bearing
7 Rolling bearing
8 Rolling bearing
9 Contact surface
10 Measurement ring
11 Dimensional scale
12 Attachment surface
13 Sensor
14 Measurement head
15 Screw
16 Screw
17 Measurement gap

1. Rolling bearing comprising an inner bearing ring and an outer bearing ring movable relative to each other, a dimensional scale that is attached to one of the inner or the outer bearing rings and a sensor attached to the other of the bearing rings that detects the dimensional scale, wherein a measurement ring that includes the dimensional scale is attached to the inner bearing ring or to the outer bearing ring.

2. Rolling bearing according to claim 1, wherein the inner bearing ring or the outer bearing ring has an attachment surface for the sensor that is arranged at a defined distance to the measurement ring or a contact surface of the measurement ring.

3. Rolling bearing according to claim 2, wherein the attachment surface for the sensor and a contact surface of the measurement ring are produced by shoe grinding.

4. Rolling bearing according to claim 1, wherein the dimensional scale of the measurement ring has an inductively detectable angular division that is scannable by the sensor which is an inductive sensor.

5. Rolling bearing according to claim 1, wherein one the measurement ring and the inner bearing ring or the measurement ring and the outer bearing ring are connected to each other by an interference fit.

6. Rolling bearing according to claim 1, wherein the inner bearing ring is rotatable and includes a thrust collar and a shaft washer connected thereto, and the measurement ring is attached to the thrust collar or the shaft washer.

7. Rolling bearing according to claim 1, wherein the sensor is an inductive sensor and is screwed to the outer bearing ring which is fixed.
